(19) United States
(12) Patent Application Publication
(10) Pub. No.: US 2017/0118096 A1
(43) Pub. Date: Apr. 27, 2017

(54) METHOD AND DEVICE FOR CONTROLLING NETWORKING CONDITION

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Yuhui CHEN, Tianjin (CN); Chao ZANG, Tianjin (CN)

(21) Appl. No.: 15/247,851

(22) Filed: Aug. 25, 2016

Related U.S. Application Data
(63) Continuation of application No. PCT/CN2016/087274, filed on Jun. 27, 2016.

(30) Foreign Application Priority Data
Oct. 22, 2015 (CN) 2015106960292

(51) Int. Cl. H04L 12/26; H04L 12/751; H04L 29/08

(52) U.S. Cl. CPC H04L 43/08; H04L 67/303; H04L 67/14; H04L 45/02

(57) ABSTRACT

The present disclosure discloses a method, apparatus and system for controlling the networking condition of a device, relates to the technical field of a network, and solves the technical problem that in the prior art, the networking condition of a certain device cannot be controlled. The method mainly comprises the steps of: acquiring a list of devices currently connected with a router; after selecting a target device whose networking condition needs to be controlled from the list, entering a special-grade control interface of the target device, and displaying special-grade control information of the target device by the special-grade control interface; and according to the setting for the special-grade control information, controlling the networking condition of the target device.

### CROSS REFERENCE TO RELATED APPLICATION

This application is a continuation of International Application No. PCT/CN2016/087274, filed on Jun. 27, 2016, which is based upon and claims priority to Chinese Patent Application No. 201510696029.2, filed on Oct. 22, 2015, the entire contents of which are incorporated herein by reference.

### TECHNICAL FIELD

The disclosure relates to the technical field of a network, and particularly relates to a method, apparatus and system for controlling a networking condition of a device.

### BACKGROUND

The networked technology is rapidly developed, and, a router is, in a network, a device connected with each Local Area Network (LAN) and each Wide Area Network (WAN) in the Internet, and can automatically select and set a route according to a condition of a channel so as to sequentially send a signal with an optimal path. The router is a hub of the Internet and is a ‘traffic police’. Currently, the router has been widely applied to all walks of life, and various different grades of products have become the main force for achieving internal connection of various backbone networks, interconnection of the backbone networks, and interconnection services between the backbone networks and the Internet.

An intelligent router is an electronic device rapidly developed in recent years, and compared with the conventional router, the intelligent router typically is provided with an independent operation system, has functions of automatically controlling a bandwidth, automatically controlling peak concurrent users, automatically controlling webpage browsing and the like, and is equipped with a mobile phone application (APP) for managing the router so as to really achieve intelligent management of the Internet and the device.

Along with popularization of a computer, a mobile device and the like, more and more children start to contact and use these devices and spend a lot more time on them. For the sake of health and school education of children, more and more parents hope to properly control and manage the situation that children use these devices to surf the Internet at home. However, in the prior art, most of users cannot know the specific situations of network access of a certain device, such as network access time, browsed URLs and the like, and even cannot interfere in the specific situations, and no solution is provided for a requirement for controlling a networking condition of a certain device.

### SUMMARY

Embodiments of the disclosure provide a method, apparatus and system for controlling a networking condition of a device, which are used for solving the technical problem existed in the prior art which is that the networking condition of a certain device cannot be controlled.

In an aspect, the embodiments of the disclosure provide a method for controlling the networking condition of the device, which includes: acquiring a list of devices currently connected with a router; after selecting a target device whose networking condition needs to be controlled from the list, entering a special-grade control interface of the target device, displaying special-grade control information of the target device through the special-grade control interface; and according to the setting for the special-grade control information, controlling the networking condition of the target device.

In another aspect, an electronic device is provided, which includes: at least one processor; and a memory communicably connected with the at least one processor for storing instructions executable by the at least one processor. Execution of the instructions by the at least one processor causes the at least one processor to: acquire a list of devices currently connected with a router; after selecting from the list, a target device whose networking condition needs to be controlled, enter a special-grade control interface of the target device, and display special-grade control information of the target device through the special-grade control interface; and according to the setting of the special-grade control information, control the networking condition of the target device.

In yet another aspect, a non-transitory computer-readable storage medium is provided. The storage medium is used for storing executable instructions that, when executed by an electronic device, cause the electronic device to: acquire a list of devices currently connected with a router; after selecting from the list, a target device whose networking condition needs to be controlled, enter a special-grade control interface of the target device, and display special-grade control information of the target device through the special-grade control interface; and according to the setting of the special-grade control information, control the networking condition of the target device.

In the embodiments of the disclosure, the technical means of providing the special-grade control interface for the selected target device to display the special-grade control information and controlling the networking condition of the target device by modifying or resetting the special-grade control information is adopted so as to solve the technical problem that in the prior art, the networking condition of the target device cannot be controlled, thereby achieving the technical effect that when the networking condition of the target device is known, the networking condition of the target device can be interfered to achieve the technical effect of reasonably arranging and controlling the networking condition of the target device.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for controlling a networking condition of a device, according to an embodiment of the disclosure;

FIG. 2 is an exemplary flow chart of a method for controlling a networking condition of a device, according to an embodiment of the disclosure and takes display of a parent control interface as an example;

FIG. 3 is a schematic diagram of a parent control interface in a method for controlling a networking condition of a device, according to an embodiment of the disclosure;

FIG. 4 is a schematic diagram of a URL filtration interface in a method for controlling a networking condition of a device, according to an embodiment of the disclosure;

FIG. 5 is an exemplary flow chart of a method for controlling a networking condition of a device, according to an embodiment of the disclosure and takes setting of parent control information as an example;

FIG. 6 is an exemplary structure chart of an apparatus for controlling a networking condition of a device, according to an embodiment of the disclosure.

FIG. 7 is a block diagram of an electronic device which can implement the method for controlling a networking condition of a device according to the disclosure.

### DETAILED DESCRIPTION

Preferred embodiments of the disclosure will be illustrated below with reference to the accompany drawings. It should be understood that the preferred embodiments described herein are only used for illustrating and explaining the disclosure, but not for limiting the disclosure.

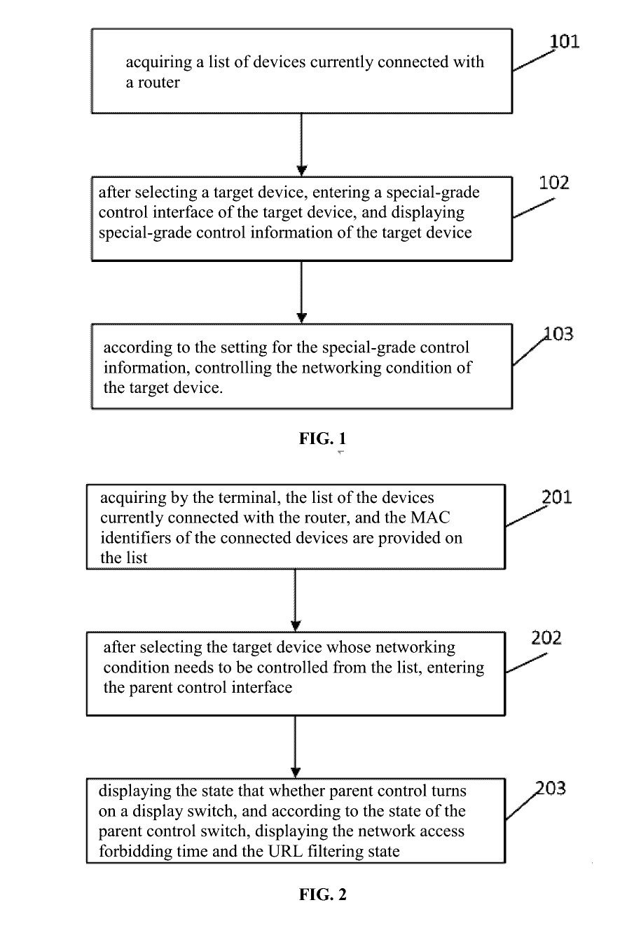

As shown in FIG. 1, an embodiment of the disclosure provides a method for controlling a networking condition of a device. The method includes:

S101, acquiring a list of devices currently connected with a router.

Acquiring the list of the devices currently connected with the router by refreshing in real time, or by entering an interface of the list of the devices connected with the router to trigger update of the list and then displaying the list of the devices currently connected, so as to ensure validity of the devices connected with the router. the devices can be represented by their identifiers, such as Media Access Control (MAC) codes, on the list.

S102, after selecting from the list, a target device whose networking condition needs to be controlled, entering a special-grade control interface of the target device, and displaying special-grade control information of the target device by the special-grade control interface.

Designating the target device whose networking condition needs to be controlled from the list, and then entering the special-grade control interface of the designated target device. The networking condition of the target device can be controlled by carrying out some operations on the special-grade control interface. the special-grade control interface will display the special-grade control information of the target device if not carrying out operations on the special-grade control interface. The information also represents a current networking condition of the target device, and the special-grade control information includes, but is not limited to: whether a special-grade control switch is on, network access forbidding time of the target device and the URL filtering condition of the target device, such as forbidding part of URLs, or forbidding all URLs, which URLs are forbidden or which URLs are accessible.

S103, according to the setting of the special-grade control information, controlling the networking condition of the target device by the router.

The special-grade control information displays information associated with the networking condition of the target device, and thus, the networking condition of the target device can be controlled by carrying out settings (including modification and resetting) on the special-grade control information. The networking condition includes network access forbidding time of the target device and the URL filtering condition of the target device, such as forbidding part of URLs, or forbidding all URLs, which URLs are forbidden or which URLs are accessible,

The method can be deployed on a terminal. The terminal can be a mobile phone, a tablet personal computer, a Personal Computer (PC) and the like. Or a router client and the like capable of implementing the scheme are mounted on the terminal.

The terminal is usually provided with an independent operation system, and has functions of automatically controlling a bandwidth, automatically controlling peak concurrent users, automatically controlling webpage browsing and the like. In an embodiment of the disclosure, by using the automatic control function and the like of the router, the networking condition of the target device can be controlled by some settings made at a terminal side by the user through the router, so that the technical problem that the networking condition of a certain device cannot be controlled is solved, thereby achieving the technical effects that the special situations of networking of the target device can be known and interfered, and the networking condition of the target device is controlled.

Preferably, the special-grade control interface includes a parent control interface.

The special-grade control information includes the state of a parent control switch, the network access forbidding time, and the URL filtering condition (including forbidding part of URLs, or forbidding all URLs, which URLs are forbidden or which URLs are accessible).

According to the embodiment, the step 103 of controlling the networking condition of the target device according to the setting for the special-grade control information includes at least one of the following: according to the situation whether the parent control switch is in an on-state, triggering the router to control the target device; according to the setting of the network access forbidding time, controlling network access time of the target device through the router; and according to the setting for URL filtration, controlling URLs accessible by the target device by means of the router.

The setting of URL filtration includes addition of the accessible URLs, and the added URLs are displayed after their top-level domains are filtered out

Correspondingly, according to the abovementioned URL filtration embodiment, in another embodiment of the disclosure, in regard to related contents of URL items, the method further includes the following steps of:

displaying the added URLs by the list; sliding each of the added URLs on the display interface by performing a gesture of sliding up and down; and deleting the added URLs by performing a gesture of sliding the added URLs left and right or by performing a clicking gesture.

In another embodiment of the disclosure, the method further includes: sending the special-grade control information and an identifier of the target device to the router for storage.

After receiving the identifier, the router can control the corresponding target device according to the special-grade control information, and also can conveniently feed inquiry result to the terminal for display when the terminal inquires the networking condition of the target device.

The following example is provided that the special-grade control interface is a parent control interface and the special control information of the interface is displayed, the embodiment provides the method for controlling the networking condition of the device, as shown in FIG. 2, comprising:

S201, acquiring by the terminal, the list of the devices currently connected with the router, and the MAC identifiers of the connected devices are provided on the list.

The parents can find the target device used by their child from the device list of the router.

S202, after selecting the target device whose networking condition needs to be controlled from the list, entering the parent control interface, simultaneously, sending the MAC of the target device selected by the parents to the router by the terminal, and if not acquiring information or not setting parent control on the router before in the process of acquiring parent control information (i.e. the special-grade control information) of the device by the router, feeding default parent control information to the parent control interface of the terminal for display.

The parent control information includes the state of the parent control switch, the network access forbidding time, and the URL filtering condition.

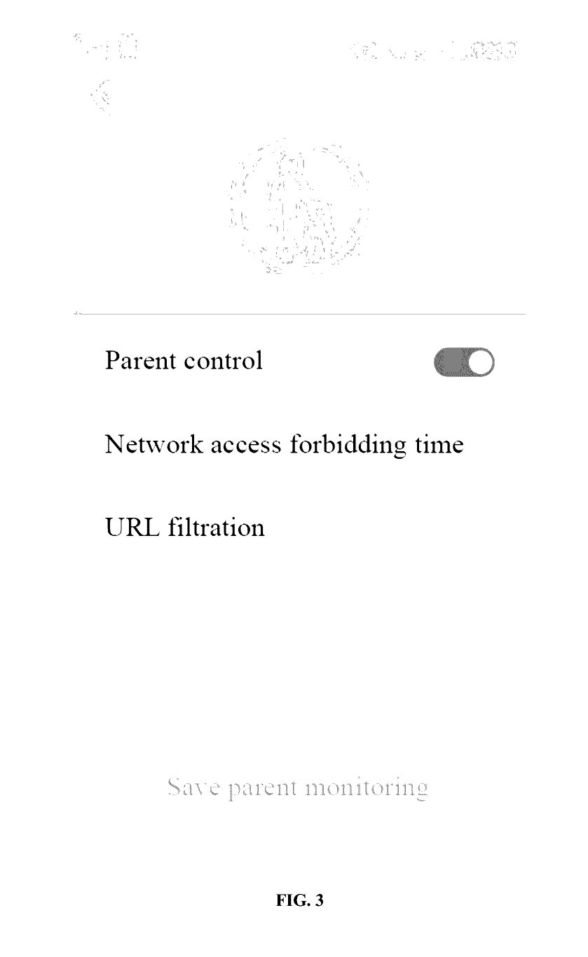

S203, according to the parent control information, particularly displaying the state that whether parent control turns on a display switch, and according to the state of the parent control switch, displaying the network access forbidding time and the URL filtering state, with reference to FIG. 3.

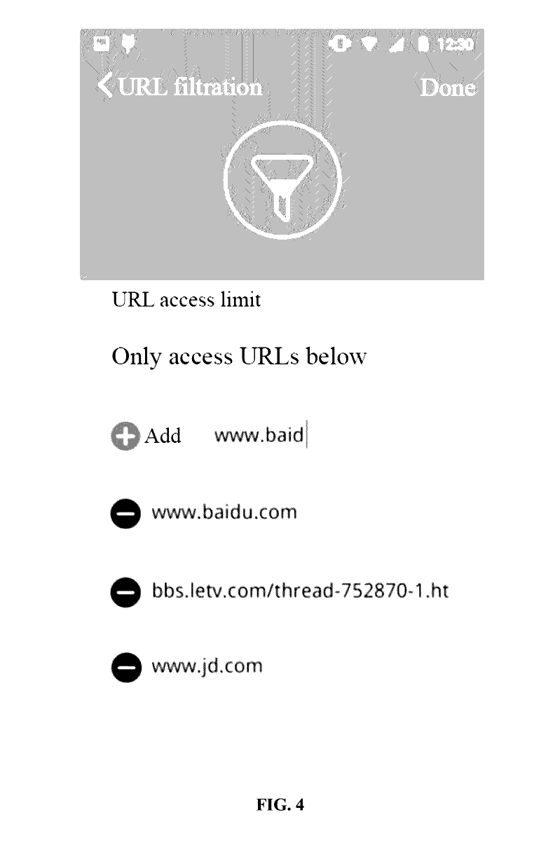

The network access forbidding time can be expressed by network access forbidding start time and end time. The parent control interface as shown in FIG. 3 can enable the network access forbidding start and end time to be saved for display on a secondary page, and the URL filtering state and saved filtered URLs are saved for being displayed on the secondary page. The secondary page can be as shown in FIG. 4.

In the method provided by the present embodiment, after entering the interface of the terminal, acquiring the MAC of the target device currently selected by a user, and then entering parent control of the target device, and according to the current MAC of the device, acquiring information of parent control corresponding to the MAC, which includes whether parent control is on, the network access forbidding start and end time, the URL filtering state and the filtered URLs, for display, so that the user can conveniently know the current networking condition of the target device.

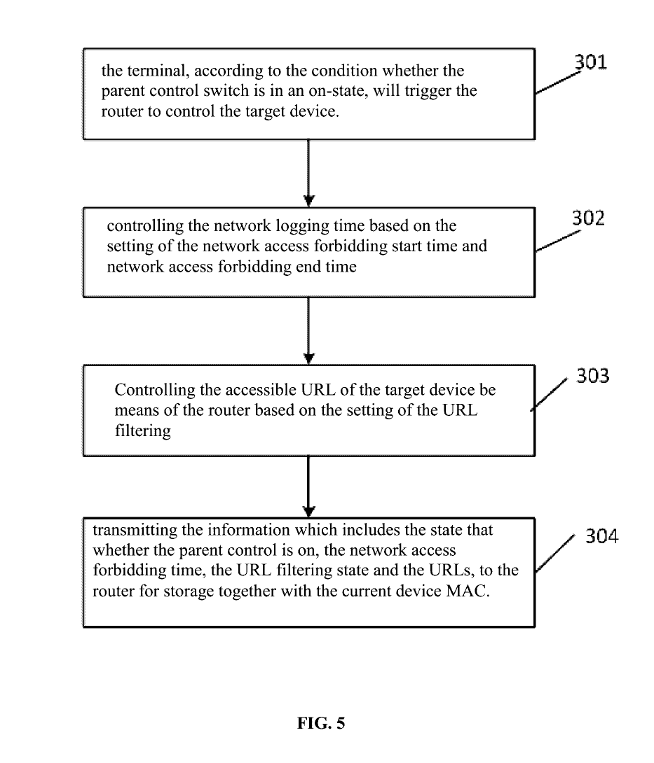

Particularly by taking the situation that the special-grade control interface is the parent control interface and the special control information is set on the interface as an example, the embodiment provides the method for controlling the networking condition of the device, as shown in FIG. 5, comprising:

S301, after entering the parent control interface of the target device, the parent control was set as to whether to switch on. The terminal, according to the condition whether the parent control switch is in an on-state, will trigger the router to control the target device.

S302, setting the network access forbidding start time and the network access forbidding end time, adding next day prompt (hint) if the network access forbidding end time is shorter than the network access forbidding start time, and recording current time selection for reentering the secondary page for display, if not setting time, defaulting the network access forbidding start time as current system time, and setting the network access forbidding end time as the start time plus 12 hours. The terminal, according to the setting for the network access forbidding start time and the network access forbidding end time, can control network access time of the target device through the router;

In an optional scheme of the step 302, an operation of inputting the network access forbidding time can be implemented by providing a time selector, which facilitates the operation of setting the network access forbidding time by a user. URL filtration creates convenience for the user to manage harmful URLs.

S303, setting the URL filtering state. As shown in FIG. 4, if setting all URLs as forbidden URLs, a URL list will not be displayed, and if setting part of URLs are forbidden, displaying an accessible URL list.

The setting for URL filtration includes execution of operations of adding and deleting URLs in the URL list. The URLs added by the user are displayed after their top-level domains are filtered out, items of the URL list can be limited to 30, and each URL includes 30 characters at most.

As shown in FIG. 4, on the interface, the added URLs are displayed through the list. Sliding each of the added URLs on the display interface is performed by a gesture of sliding up and down; and deleting the added URLs is performed by a gesture of sliding the added URLs left and right or by a clicking gesture.

Specifically, adding the URL list, carrying out clicking and sliding deletion on the URL list, displaying all of the list by sliding up and down.Layout display URLScrollView supports up-and-down sliding, and URLListView and UrlListltemView support click deletion and sliding deletion.

For example, (1) at the outermost layer, URL state items, added URL items and the URLListView are added by the URLScrollView.

(2) when the gesture of sliding up and down is performed, the URLScrollView will intercept the gesture of sliding up and down to carry out sliding processing; and when the gesture of sliding left and right is performed, the URLScrollView does not process the gesture and transmits the gesture to a sub View (UrlListltemView) for processing, and then the sub view UrlListltemView transmits the gesture to the UrlListltemView to carry out an operation of sliding left and right.

(3) deleting an item from the UrlListltemView deletes in a clicking manner or a sliding manner includes, by a Scroller, moving a View of a deletion button into a screen, clicking on the View to carry out deletion monitoring, and then deleting the item, refreshing the UrlListltemView, moving next item to a current position and updating display.

S304, by the terminal, transmitting the information, which is modified by parent control currently and includes the state that whether the parent control is on, the network access forbidding time, the URL filtering state and the URLs, to the router for storage together with the current device MAC.

The steps 301 to 304 above can be carried out in any sequence, and is not limited to the mode described in the above mentioned embodiments.

In the example provided by the embodiment, parents can find the device used by their child from the device list of the router, and enter the parent control interface to set time limit for network access every day; and for URL filtration, the setting could be forbidding all URLs from access, and also could be forbidding part of URLs which are not wished to be accessed by children from access, thereby achieving control to the networking condition of the target device.

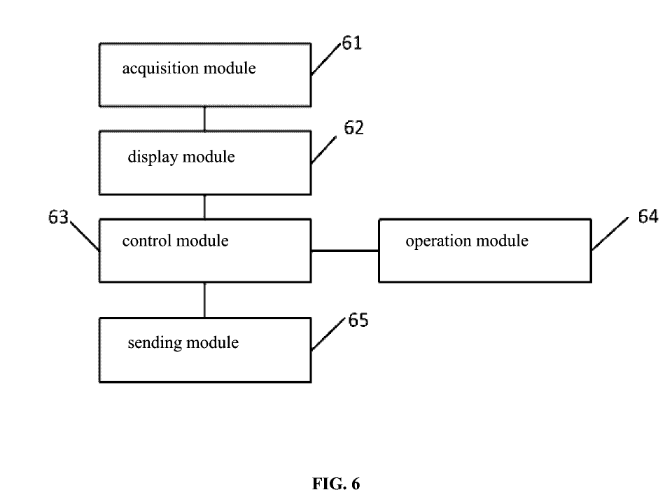

In order to facilitate implementation of the methods in FIG. 1, FIG. 2 and FIG. 5, the embodiment particularly provides an apparatus for controlling a networking condition of a device shown in FIG. 6. The apparatus can be one terminal, also can be a client installed on the terminal, and includes: an acquisition module 61, a display module 62 and a control module 63.

The acquisition module 61 is used for acquiring a list of devices currently connected with a router; the display module 62 is used for displaying special-grade control information of the target device on the special-grade control interface by entering a special-grade control interface of a target device after selecting the target device whose networking condition needs to be controlled from the list; and the control module 63 is used for controlling the networking condition of the target device according to the setting for the special-grade control information.

The special-grade control interface comprises a parent control interface; and the special-grade control information comprises the state of a parent control switch, network access forbidding time, and URL filtering condition.

The control module 63 is particularly used for executing at least one of the following steps of: according to the situation whether the parent control switch is in an on-state, triggering the router to control the target device; according to the setting for the network access forbidding time, controlling network access time of the target device through the router; and according to the setting for URL filtration, controlling URLs accessible by the target device by means of the router.

Optionally, the setting for URL filtration by the control module 63 comprises addition of the accessible URLs, and the added URLs are displayed after their top-level domains are filtered out.

Optionally, the apparatus further comprises: an operation module 64, which is used for displaying the added URLs by the list, sliding each of the added URLs on the display interface by performing a gesture of sliding up and down, and deleting the added URLs by performing a gesture of sliding the added URLs left and right or by performing a clicking gesture.

Optionally, the apparatus further comprises: a sending module 65, which is used for sending the special-grade control information and an identifier of the target device to the router for storage.

The apparatus provided by the embodiment of the disclosure has functions of providing the special-grade control interface to the selected target device to display the special-grade control information and controlling the networking condition of the target device by modifying or resetting the special-grade control information, thus solving the technical problem that in the prior art, the networking condition of the target device cannot be controlled, and further achieving the technical effect that when the networking condition of the target device is known, the networking condition of the target device can be interfered to achieve reasonable arrangement and control on the networking condition of the target device.

The embodiment also provides a system for controlling a networking condition of a device, comprising: a router and the apparatus for controlling the network condition of the device as shown in FIG. 6.

The router is used for controlling the networking condition of a target device according to the setting for special-grade control information on the apparatus for controlling the network condition of the device. Specific functions of the apparatus for controlling the networking condition of the device are similar with those of the apparatus shown in FIG. 6, and are not repeated herein.

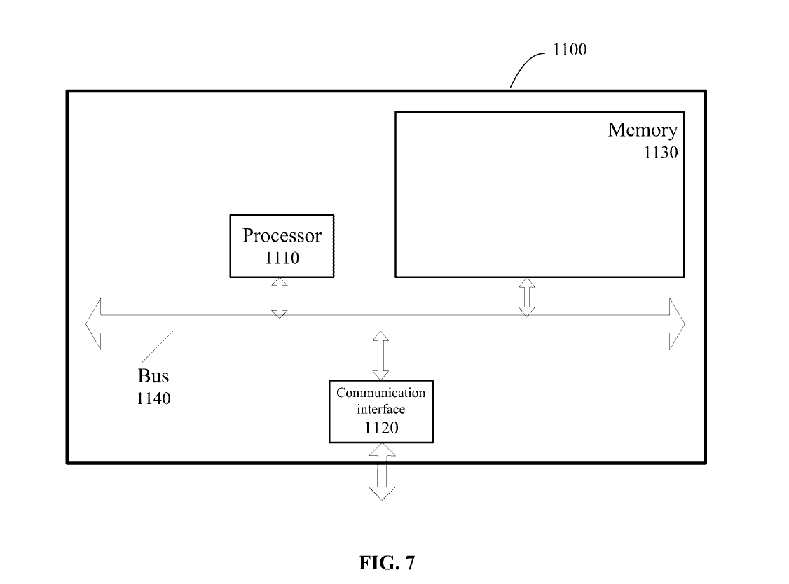

FIG. 7 is a block diagram of an electronic device which can implement the method for controlling a networking condition of a device according to the disclosure. The electronic device 1100 may be a host server, a personal computer (PC), or a portable computer or terminal and the like with computing power. The specific embodiments of the disclosure do not limit concrete implementation of computing nodes.

The electronic device 1100 comprises a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element comprises, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the disclosure.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned programs may be program codes including computer operating instructions that can be configured to: acquire a list of devices currently connected with a router; after selecting a target device whose networking condition needs to be controlled from the list, enter a special-grade control interface of the target device, and display special-grade control information of the target device through the special-grade control interface; and according to the setting for the special-grade control information, control the networking condition of the target device.

In a possible embodiment of the computer program, the special-grade control interface comprises a parent control interface; and the special-grade control information comprises the state of a parent control switch, network access forbidding time, and URL filtering condition.

In a possible embodiment of the computer program, wherein the step of controlling the networking condition of the target device according to the setting for the special-grade control information comprises at least one of the following steps: according to the situation whether the parent control switch is in an on-state, triggering the router to control the target device; according to the setting for the network access forbidding time, controlling network access time of the target device through the router; and according to the setting of URL filtration, controlling URLs accessible by the target device by means of the router.

In a possible embodiment of the computer program, the setting of URL filtration comprises addition of the accessible URLs, and the added URLs are displayed after their top-level domains are filtered out; and the method further comprises: displaying the added URLs by means of the list; sliding each of the added URLs on the display interface by performing a gesture of sliding up and down; and deleting the added URLs by performing a gesture of sliding the added URLs left and right or by performing a clicking gesture.

In a possible embodiment of the computer program, the program is further designed for: sending the special-grade control information and an identifier of the target device to the router for storage.

Those skilled in the art should understand that the embodiments of the disclosure can provide the method, the system or a computer program product. Therefore, the disclosure can adopt a form of full hardware embodiments, full software embodiments or embodiments combining software and hardware aspects. Moreover, the disclosure can adopt a form of the computer program product implemented on one or a plurality of computer available storage media (including, but not limited to, a magnetic disk storage, an optical storage and the like) with computer available program codes.

The disclosure is described with reference to flow charts and/or block diagrams of the method, the device (system) and the computer program product according to the embodiments of the disclosure. It should be understood that each flow and/or block in the flow charts and/or the block diagrams and combination of the flows and/or the blocks in the flow charts and/or the block diagrams can be achieved by computer program instructions. The computer program instructions can be provided to a universal computer, a special purpose computer, an embedded processor or processors of other programmable data processing equipment to generate a machine, so that by the instructions executed by the computer or the processors of other programmable data processing equipment, an apparatus for implementing designated functions in one or more flows of the flow charts and/or one or more blocks of the block diagrams is generated.

It is evident that those skilled in the art can make various changes or modifications to the disclosure without departing from the spirit and scope of the disclosure. Thus, if these changes and modifications to the present disclosure are within the scope of the claims of the disclosure and equivalent technologies, the disclosure also intends to include all such changes and modifications within its scope.

What is claimed is:

1. A method for controlling a networking condition of a device, comprising:
acquiring a list of devices currently connected with a router;
after selecting from the list, a target device whose networking condition needs to be controlled, entering a special-grade control interface of the target device, and displaying special-grade control information of the target device through the special-grade control interface; and
according to the setting of the special-grade control information, controlling the networking condition of the target device.

2. The method according to claim 1, wherein the special-grade control interface comprises a parent control interface; and the special-grade control information comprises the state of a parent control switch, network access forbidding time, and URL filtering condition.

3. The method according to claim 2, wherein the step of controlling the networking condition of the target device according to the setting for the special-grade control information comprises at least one of the following steps:
according to the situation whether the parent control switch is in an on-state, triggering the router to control the target device;
according to the setting of the network access forbidding time, controlling network access time of the target device through the router; and
according to the setting of URL filtration, controlling URLs accessible by the target device by means of the router.

4. The method according to claim 3, wherein the setting of URL filtration comprises addition of the accessible URLs, and the added URLs are displayed after their top-level domains are filtered out; and the method further comprises:
displaying the added URLs by means of the list; sliding each of the added URLs on the display interface by performing a gesture of sliding up and down; and deleting the added URLs by performing a gesture of sliding the added URLs left and right or by performing a clicking gesture.

5. The method according to claim 1, further comprising:
sending the special-grade control information and an identifier of the target device to the router for storage.

6. An electronic device, comprising:
at least one processor; and
a memory communicably connected with the at least one processor for storing instructions executable by the at least one processor, wherein execution of the instructions by the at least one processor causes the at least one processor to:
acquire a list of devices currently connected with a router;
after selecting from the list, a target device whose networking condition needs to be controlled, enter a special-grade control interface of the target device, and display special-grade control information of the target device through the special-grade control interface; and
according to the setting of the special-grade control information, control the networking condition of the target device.

7. The electronic device according to claim 6, wherein the special-grade control interface comprises a parent control interface; and the special-grade control information comprises the state of a parent control switch, network access forbidding time, and URL filtering condition.

8. The electronic device according to claim 6, wherein during the operation of controlling the networking condition of the target device according to the setting for the special-grade control information, the at least one processor is caused to:
according to the situation whether the parent control switch is in an on-state, trigger the router to control the target device;
according to the setting of the network access forbidding time, control network access time of the target device through the router; and
according to the setting of URL filtration, control URLs accessible by the target device by means of the router.

9. The electronic device according to claim 8, wherein the setting of URL filtration comprises addition of the accessible URLs, and the added URLs are displayed after their top-level domains are filtered out; and execution of the instructions by the at least one processor further causes the at least one processor to:
display the added URLs by means of the list; sliding each of the added URLs on the display interface by performing a gesture of sliding up and down; and delete the added URLs by performing a gesture of sliding the added URLs left and right or by performing a clicking gesture.

10. The electronic device according to claim 6, wherein execution of the instructions by the at least one processor further causes the at least one processor to:
send the special-grade control information and an identifier of the target device to the router for storage.

11. A system for controlling a networking condition of a device, comprising: a router and the electronic device according to claim 6, wherein
the router is used for controlling the networking condition of a target device according to the setting for special-grade control information on the electronic device.

12. A non-transitory computer-readable storage medium storing executable instructions that, when executed by an electronic device, cause the electronic device to:
acquire a list of devices currently connected with a router;
after selecting from the list, a target device whose networking condition needs to be controlled, enter a special-grade control interface of the target device, and display special-grade control information of the target device through the special-grade control interface; and
according to the setting of the special-grade control information, control the networking condition of the target device.
